(19) United States
(12) Patent Application Publication
(10) Pub. No.: US 2013/0062336 A1
(43) Pub. Date: Mar. 14, 2013

(54) Heater

(71) Applicants: Ji Yong Zhang, Foshan (CN); Kai Zhou, Foshan (CN)

(72) Inventors: Ji Yong Zhang, Foshan (CN); Kai Zhou, Foshan (CN)

(21) Appl. No.: 13/229,806

(22) Filed: Sep. 12, 2011

(51) Int. Cl. H05B 3/02; H05B 3/40

(52) U.S. Cl. 219/530

(57) ABSTRACT

Heater having an enclosure surrounding a heating core. The heating core includes heating elements and a self-supporting corrugated heat conductive fin that provides air flow channels between the corrugations as well as multiple heat reflective surfaces.

### FIELD OF THE INVENTION

The present invention relates generally to a space heater, and more particularly to a portable convection and radiation space heater.

### BACKGROUND OF THE INVENTION

Convection space heaters have been developed, such as the heater described in U.S. Pat. No. 6,901,213 B2, issued to Bing Bai on May 31, 2005. This device has many parts, making it expensive and time-consuming to construct.

Thus, there is a need for a convection heater that can be produced inexpensively and efficiently.

### SUMMARY OF THE INVENTION

To achieve the foregoing and other objects and in accordance with the purpose of the present invention broadly described herein, one embodiment of this invention comprises a heating core for a heater. The core comprises a corrugated heat conductive fin having, a first end panel attached to a first end of the fin, a second end panel attached to a second end of the fin; and at least one heating element mounted to and extending between the first and second end panels. The fin is self-supporting between the first and second end panels.

The heating core may further comprise an additional panel attached to the first and second end panels, with a space between the additional panel and the fin. There may be a plurality of air channels between corrugations of the fin. The heating core may further comprise means for providing structural stability to the heating core, such as straps joining the side panels. The heating core may further comprise a plurality of heating elements. At least some of the heating elements may extend through holes in the fin and/or at least some of the heating elements may not extend through holes in the fin.

Another embodiment of the invention comprises a convection heater. The heater comprises a ventilated enclosure and a heating core mounted within the enclosure. The heating core comprises a corrugated heat conductive fin, a first end panel attached to a first end of the fin, a second end panel attached to a second end of the fin, at least one heating element mounted to and extending between the first and second end panels, and means for providing structural stability to the heating core.

The heater may further comprise an additional panel attached to the first and second end panels, with a space between the additional panel and the fin. The means for providing structural stability may comprise straps joining the side panels. There may be a plurality of heating elements. At least some of the heating elements may extend through holes in the fin, and/or at least some of the heating elements may not extend through holes in the fin. The convection heater may further comprise means for supporting the heater on a substantially horizontal surface, and the means for supporting may be selected from castors, legs, and combinations thereof. There may be means for controlling the heating element, selected from temperature controllers, power controllers, and combinations thereof. The convection heater may further comprise handles.

### BRIEF DESCRIPTION OF THE DRAWINGS

These and other features, aspects, and advantages of the present invention will become better understood with reference to the following description, appended claims, and accompanying drawings, where:

FIG. 1 is a front perspective view of a convection heater of the present invention;

FIG. 2 is a front perspective exploded view of the convection heater of FIG. 1;

FIG. 3 is a front perspective view of the heating core of the convection heater of FIG. 1;

FIG. 4 is a front view of the heating core of FIG. 3;

FIG. 5 is a top view of the heating core of FIG. 3;

FIG. 6 is a front perspective view of a conductive fin of the heating core of FIG. 3;

FIG. 7 is a right side view of a portion of the heating core of a second embodiment of a heating core in accordance with the present invention;

FIG. 8 is a top view of a third embodiment of a heating core in accordance with the present invention;

FIG. 9 is a top view of a fourth embodiment of a heating core in accordance with the present invention;

FIGS. 10-13 are perspective views showing steps for assembling the heating core of FIG. 3;

FIGS. 14-17 are perspective views showing steps for assembling an enclosure for the heating core of FIG. 3;

FIG. 18 is a front perspective view showing the steps for positioning the heating core in the enclosure; and

FIGS. 19-21 are front perspective views showing additional steps for assembling the heater enclosure.

### DESCRIPTION OF THE PREFERRED EMBODIMENT

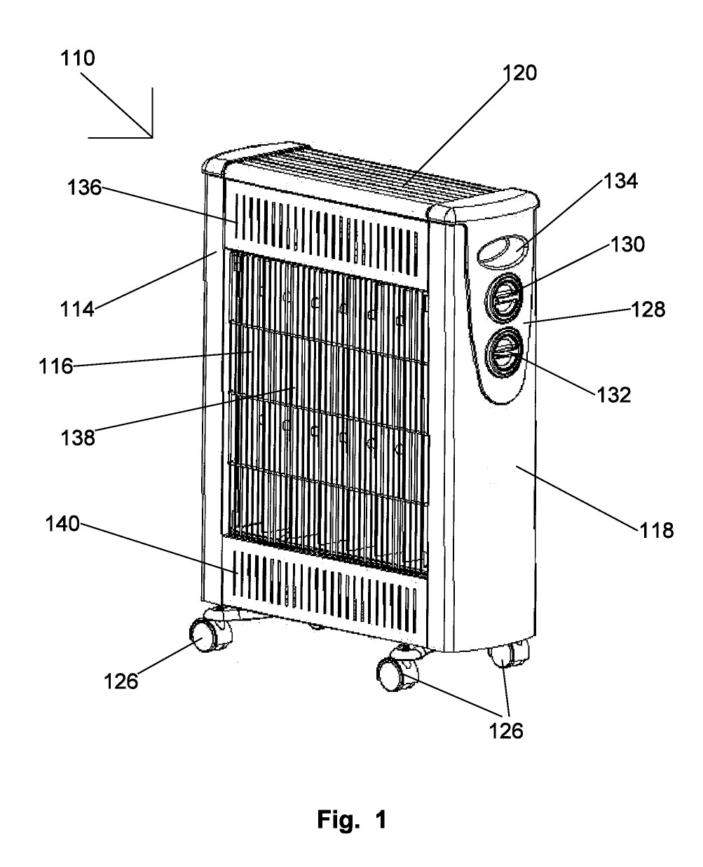

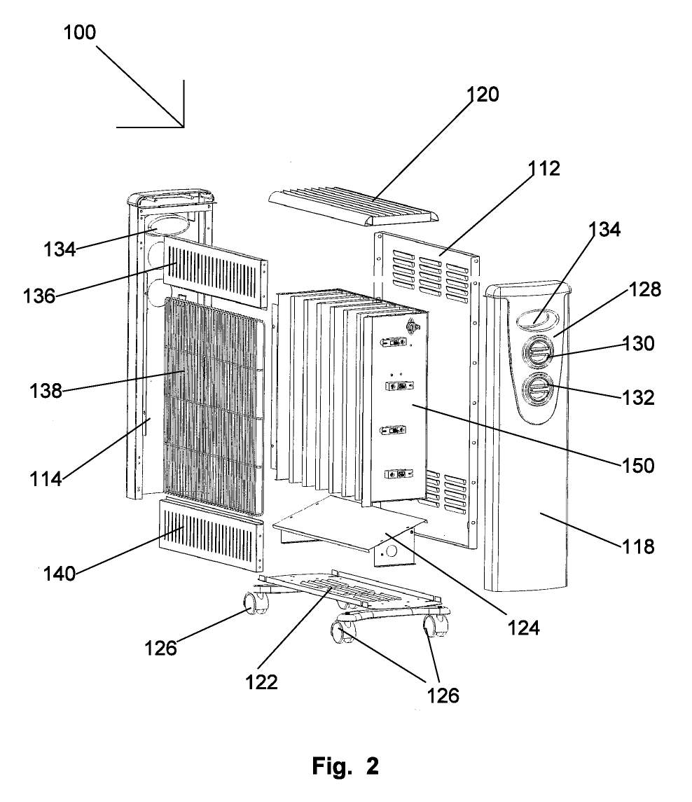

The present invention comprises a space heater 100 which is preferably portable and easily moved from one room or space to another. Because it is a convection heater, it may operate quietly without a fan. The heater may include a fan to accelerate convection. In the following discussion, terms of orientation, such as “top,” “bottom,” “left,” “right,” “upper,” “lower,” “front,” and “rear,” refer to components as the heater as viewed in FIGS. 1 and 2 and are not meant to limit the orientation of the heater. Similar features in different embodiments of the heater are identified with the same callout numbers.

Referring to FIGS. 1 and 2, heater 100 comprises a heating core 150 mounted into an enclosure 110. The enclosure 110 comprises a rear cover 112, a left side cover 114, a front cover 116, a right side cover 118, a top cover 120, and an air inlet board 122. Air inlet board 122 supports covers 112, 114, 116, 118, and 120. A reflector 124 is mounted onto the upper surface of air inlet board 122 and within the enclosure formed between the rear cover 112, left side cover 114, right side cover 118, front cover 116, and top cover 120. Castors 126 may be mounted onto the lower surface of air inlet board 122. Although castors are preferred for ease of moving heater 100 from one room or space to another, they could be replaced with legs, feet, or any other desired support (not shown). As shown, a control panel 128 is mounted onto the exterior surface of right side cover 118 and includes a temperature control 130 and a heating power control 132. Alternatively, the controls 130 and 132 could be mounted onto left side cover 114 or elsewhere on the heater. Preferably, handles 134 may be provided in right and left side covers 114 and 118 to aid in moving the heater 100. Handles 134 may be formed from a heat-insulating material, such as ABS plastic, allowing heater 100 to be moved while the heater is operating.

As shown, rear cover 112, front cover 116, top cover 120, and air inlet board 122 all include perforations that allow free air flow through the covers and into and out of heater 100. Preferably, front cover 116 comprises three portions, a front top grill 136, a front grill 138, and a front bottom grill 140. Rear cover 112, front cover 116, top cover 120, air outlet grill, air inlet board 122, and bottom reflector 124 are preferably formed from a material that provides sufficient heat tolerance, rigidity, strength, and durability for long-term use of heater 100. Such materials include metals and metal alloys. A preferred material is aluminum, which may be provided in sheets that are cut and bent as needed. Control panel 128 may be formed from an electrically insulating material, such as ABS plastic.

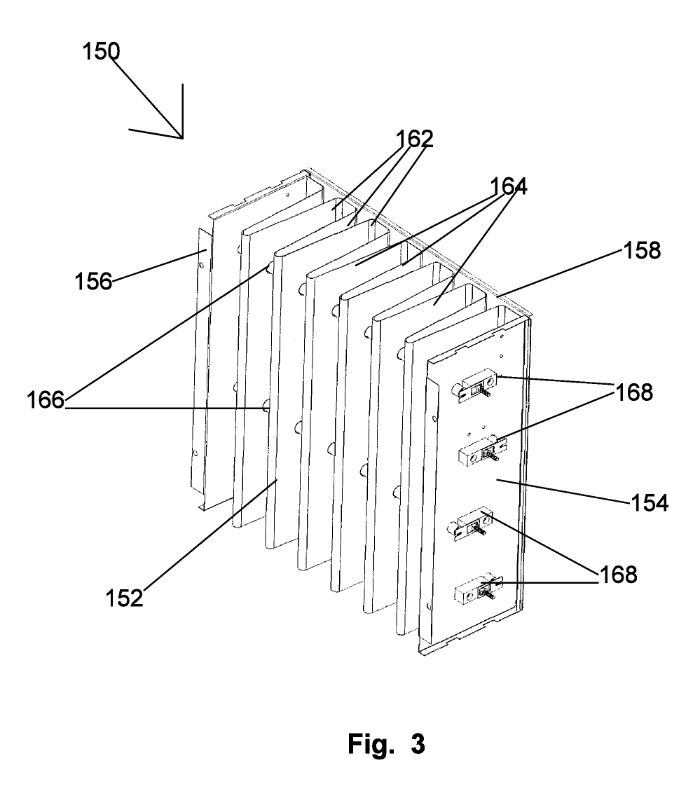

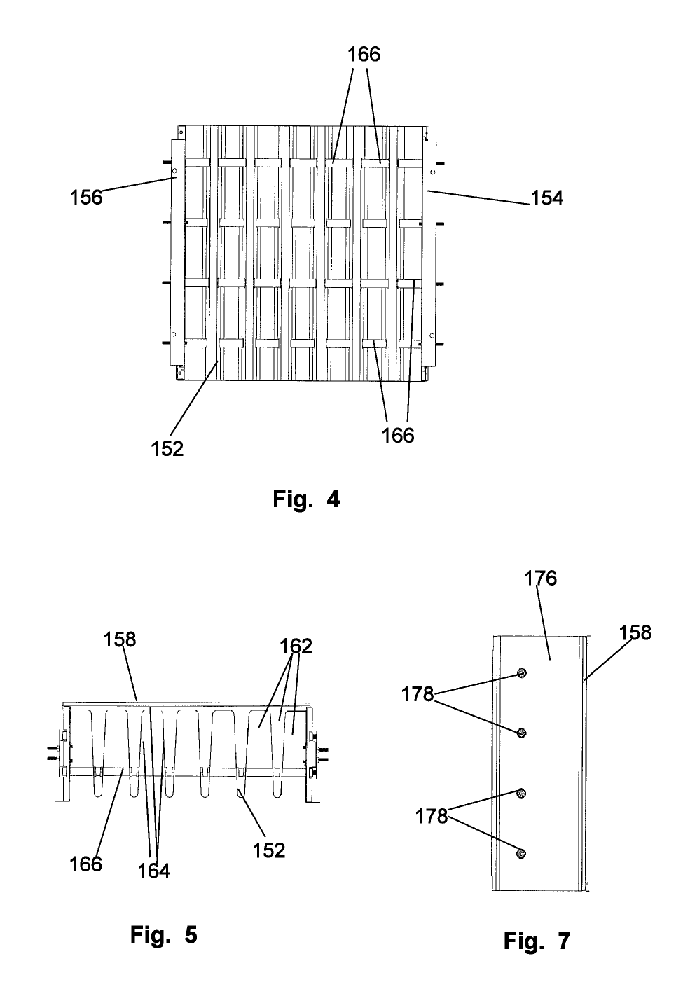

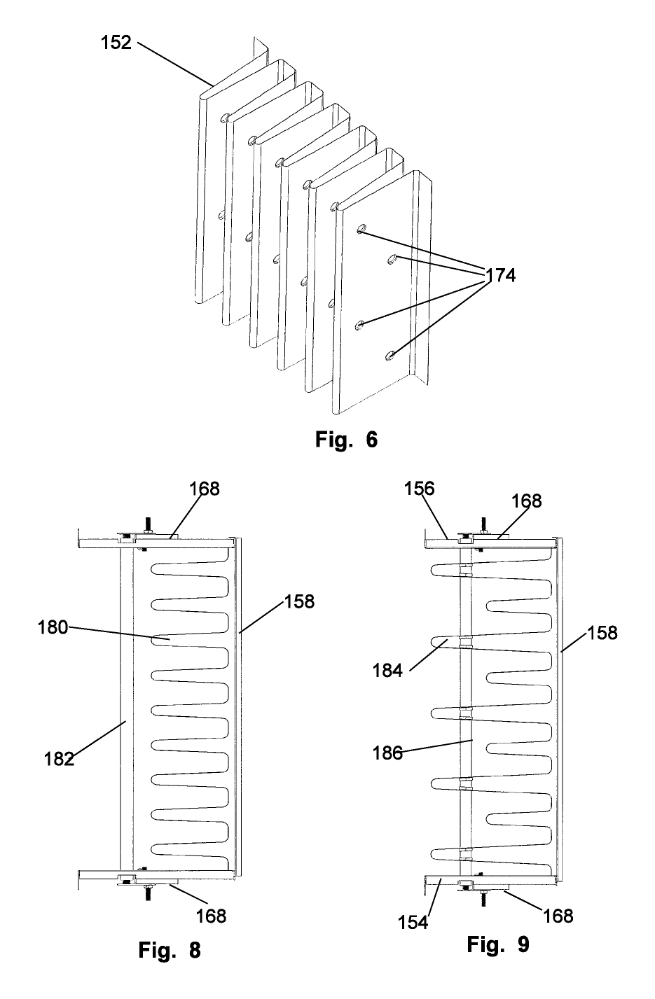

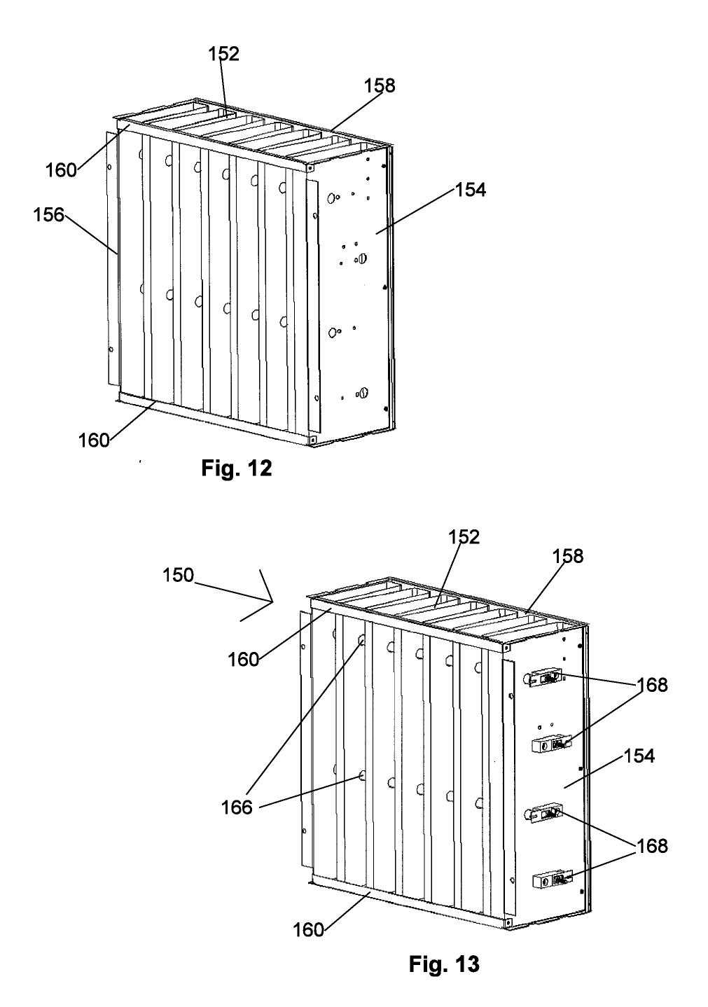

Heating core 150 can be understood with reference to FIGS. 3-6. A conductive fin 152 is mounted between a right side panel 154 and a left side panel 156. A rear panel 158 is mounted onto side panels 154 and 156, and fastening straps 160 (shown in FIGS. 12 and 13) are mounted onto the front portions of the side panels 154 and 156. Alternatively, other means could be used instead of straps 160 to provide structural integrity and rigidity to the heating core 150 and to aid in assembling the heater 100 as described below. Conductive fin 152 may comprise a corrugated, waved, or folded sheet of heat conductive material with sufficient rigidity to be self-supporting between side panels 154 and 156. The corrugated structure provides multiple heat conductive channels 162 with multiple heat reflective surfaces 164 to enhance convection efficiency and provide heat via radiation. Heating elements 166 extend through and/or in front of conductive fin 152, and are retained by holders 168. As shown in FIGS. 3-5, heating elements 166 extend through holes in conductive fin 152. As shown in FIG. 8, heating elements 166 may be positioned between side panels 154 and 156 and in front of fin 152. Alternatively, as shown in FIG. 9, the corrugations or folds of heat conductive fin 152 may have different dimensions, with heating elements 166 passing through some of the corrugations and in front of others. Conductive fin 152, side panels 154 and 156, and rear panel 158 may be formed from any material with sufficient rigidity, heat conductivity, and durability. A preferred material is aluminum, which may be provided in sheets and then cut and bent as desired. Heating elements 166 may be formed as known in the art from any suitable resistive material, such as copper wire. Rear cover 112, left side cover 114, front cover 116, right side cover 118, top cover 120, air inlet board 122, and reflector 124 may be formed from sheet metal by stamping, cutting, and/or bending the sheet. Plastic components may be molded, such as by injection molding.

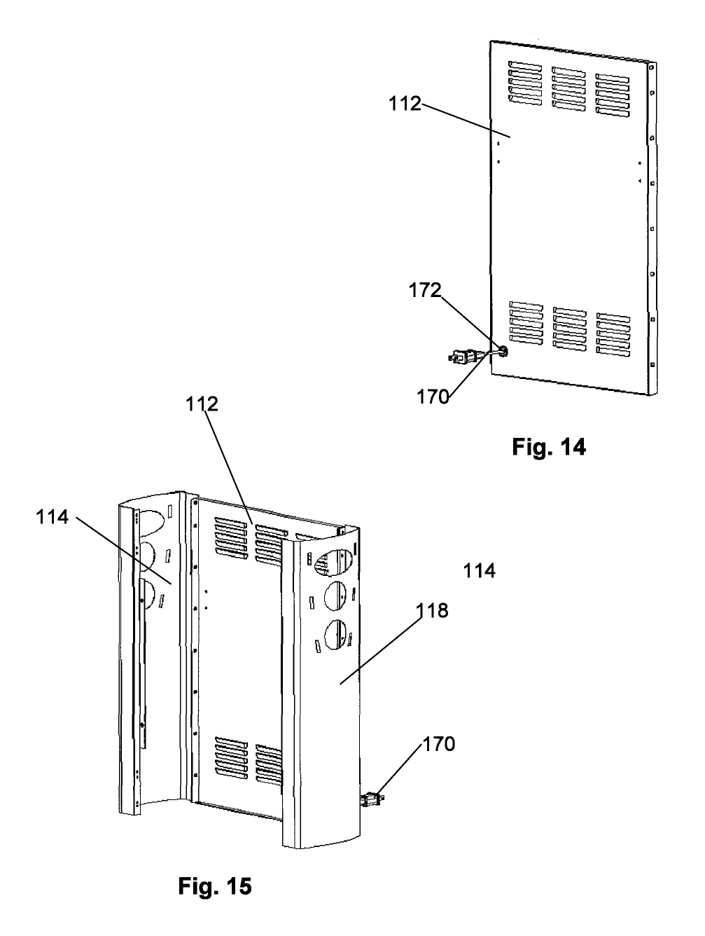

The heater 100 also includes electrical circuitry and components, not shown, for controlling heating elements. Preferably, a temperature controller is positioned immediately behind temperature control 130, and a power controller is positioned immediately behind power control 132. As shown in FIGS. 14-19, a power cord 170, with a plug suitable for insertion into a wall receptacle, passes through a hole in rear cover 112. Alternatively, the power cord 170 could pass through a different part of the enclosure 110, such as through right side cover 118, left side cover 114, or air inlet board 122. Bottom reflector 124 protects wires and other components from exposure to high temperatures generated by the heating elements.

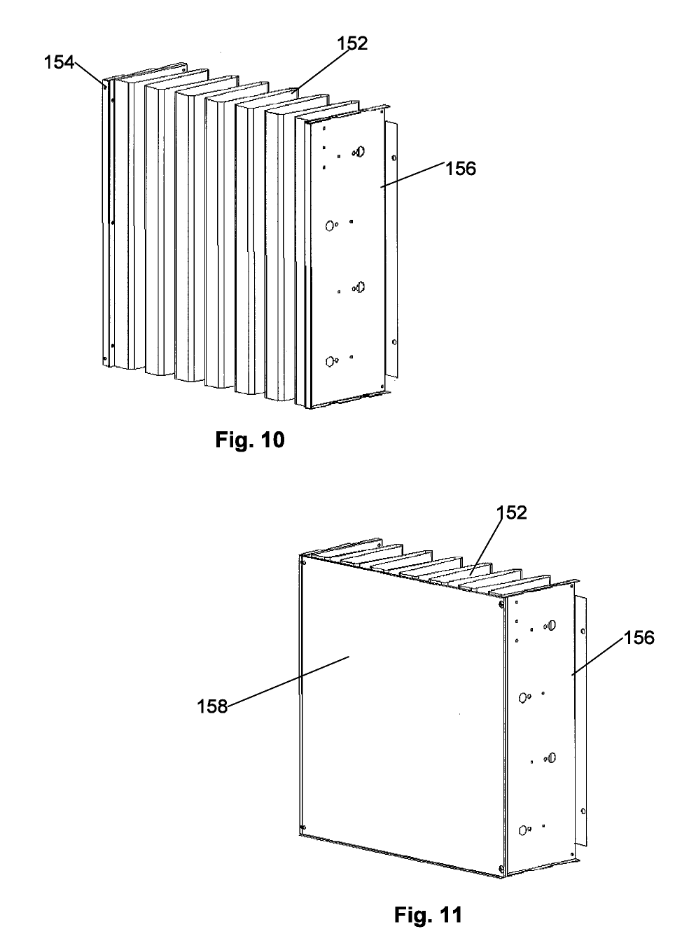

Heater 100 may be assembled as shown in FIGS. 10-19. Heating core 150 may be assembled by mounting right side panel 154 and left side panel 156 onto conductive fin 152, shown in FIG. 10. Rear panel 158 is secured to side panels 154 and 156, shown in FIG. 11, and straps 160 are secured to side panels 154 and 156, shown in FIG. 12. Heating elements 166 are placed through openings in side panels 154 and 156 and through or in front of conductive fin 152, shown in FIG. 13.

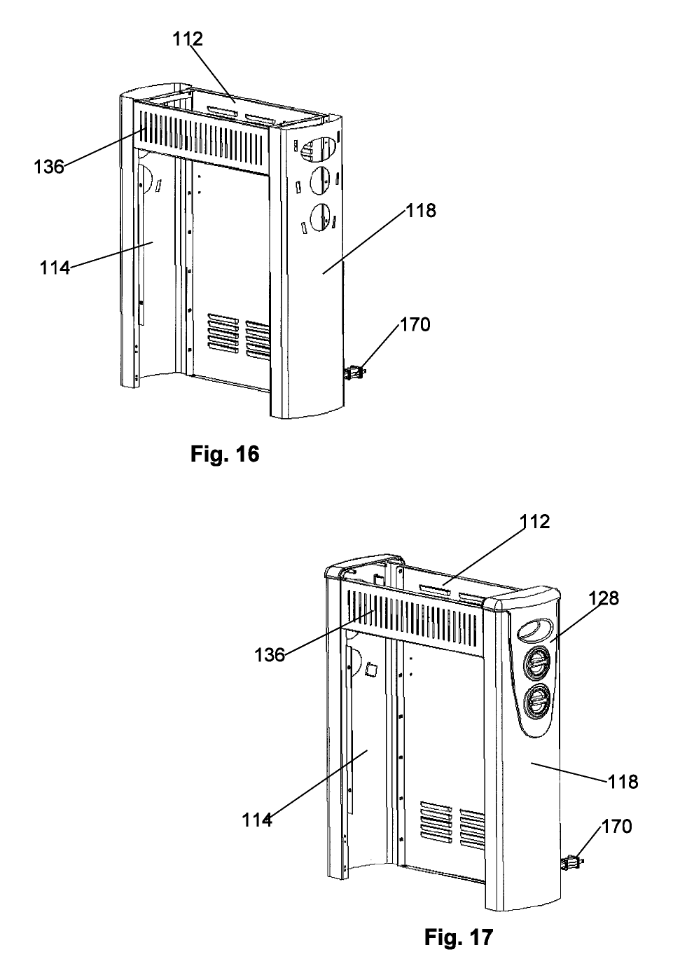

The enclosure 110 that surrounds heating core 150 may be assembled by inserting cord 170 through an opening 172 in rear cover 112, shown in FIG. 14, and joining the left side cover 114 and right side cover 118 to rear cover 112, shown in FIG. 15. Front top grill 136 is fixed to the upper portions of right side cover 118 and left side cover 114, shown in FIG. 16. Referring to FIG. 17, control panel 128 is mounted onto right side cover 118.

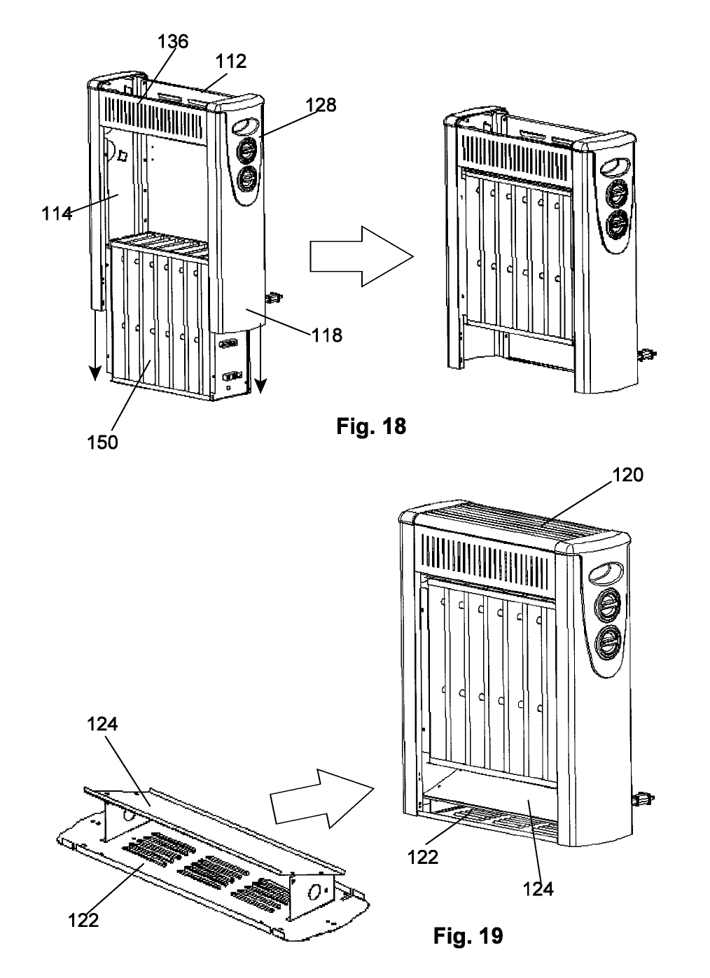

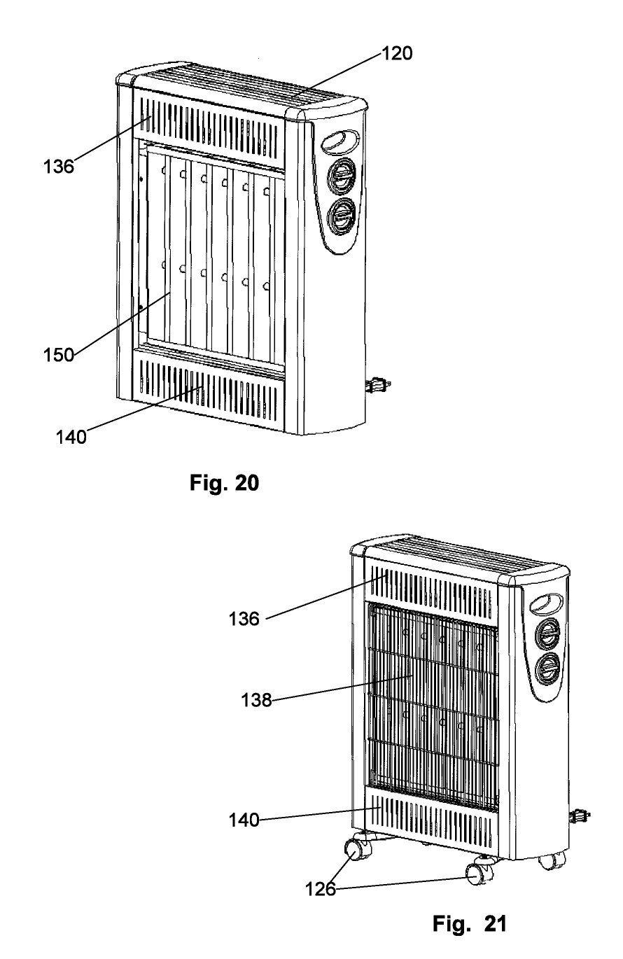

The enclosure assembly formed with left side cover 114, right side cover 118, rear cover 112, and front top grill 156 may be slid over the assembled heating core 150, shown in FIG. 18. Referring to FIG. 19, bottom reflector 124 is mounted onto the air inlet board 122, and then air inlet board 122, with the reflector 124 attached, is mounted to the lower portions of the left side cover 114, right side cover 118, and rear cover 112. Top cover 120 is secured onto the left, right, and rear covers and front top grill, and front bottom grill 140 is secured onto the side covers 114 and 118, shown in FIG. 20. Front grill 138 is attached to the side covers 114 and 118, and castors 126 are mounted onto the bottom of air inlet board 122, shown in FIG. 21.

Any suitable devices and methods may be used to join the various components to each other. For example, fasteners, such as screws and nuts, may be used.

As shown in FIGS. 2, 3, and 6, conductive fin 152 has holes 174 placed at varying distances from the front and back corrugations. Other arrangements of the heating elements and the conductive fin are possible and within the scope of the invention. It may be desirable to place the heating elements in an arrangement other than the array shown in FIGS. 2, 3, and 6. For example, as shown in FIG. 7, right side panel 176 and the left side panel and conductive fin (not shown) and the conductive fin (not shown) may have vertically aligned holes 178 to accommodate the heating elements 166 that pass through the conductive fin. Alternatively, conductive fin 180 may be positioned entirely behind heating elements 182, shown in FIG. 8. The corrugations of the conductive fin need not all have the same depth from front to back. For example, shown in FIG. 9, fin 184 has corrugations with alternating depths, and heating elements 186 pass through the front portions of the deeper corrugations and do not intersect the shallower corrugations.

Because the corrugated fin of the heater may be formed from a single sheet of metal, it allows inexpensive and efficient manufacturing of the heater by decreasing the number of parts and simplifying assembly of the heater, relative to previous heaters. The corrugated fin surface and channels provide heating by both convection and radiation.

The foregoing description is considered as illustrative only of the principles of the invention. Further, since numerous modifications and changes will readily occur to those skilled in the art, it is not desired to limit the invention to the exact construction and process shown and described above. Accordingly, all suitable modifications and equivalents may be resorted to falling within the scope of the invention.

### LIST OF CALLOUT FEATURES

FIGS. 1-6
heater 100
enclosure 110
rear cover 112
left side cover 114
front cover 116
right side cover 118
top cover 120
air inlet board 122
reflector 124
castors 126
control panel 128
temperature control 130
heating power control 132
handles 134
front top grill 136
front grill 138
front bottom grill 140
heating core 150
conductive fin 152
right side panel 154
left side panel 156
rear panel 158
straps 160
heat conductive channels 162
heat reflective surfaces 164
heating elements 166
heating element holders 168
power cord 170
hole for power cord 172
holes for heating elements 174
FIG. 7
right side panel 176
holes 178
FIG. 8
conductive fin 180
heating elements 182
FIG. 9
fin 184
heating elements 186

What is claimed is:

1. A heating core for a heater, said heating core comprising:
a corrugated heat conductive fin;
a first end panel attached to a first end of said fin;
a second end panel attached to a second end of said fin; and
at least one heating element mounted to and extending between said first and second end panels;
wherein said fin is self-supporting between said first and second end panels.

2. The heating core of claim 1, further comprising an additional panel attached to said first and second end panels, with a space between said additional panel and said fin.

3. The heating core of claim 1, having a plurality of air channels between corrugations of said fin.

4. The heating core of claim 3, further comprising means for providing structural stability to said heating core.

5. The heating core of claim 4, wherein said means for providing structural stability comprises straps joining front portions of said side panels.

6. The heating core of claim 1, further comprising a plurality of heating elements.

7. The heating core of claim 6, wherein at least some of said heating elements extend through holes in said fin.

8. The heating core of claim 6, wherein at least some of said heating elements do not extend through holes in said fin.

9. A convection heater, said heater comprising:
a ventilated enclosure;
a heating core mounted within said enclosure, said heating core comprising;
a corrugated heat conductive fin;
a first end panel attached to a first end of said fin;
a first end panel attached to a second end of said fin;
a second end panel attached to said second side portion;
at least one heating element mounted to and extending between said first and second end panels; and
means for providing structural stability to said heating core inside said enclosure.

10. The convection heater of claim 9, further comprising an additional panel attached to said first and second end panels, with a space between said additional panel and said fin.

11. The heating core of claim 9, wherein said means for providing structural stability comprises straps joining said side panels.

12. The convection heater of claim 9, further comprising a plurality of heating elements.

13. The convection heater of claim 12, wherein at least some of said heating elements extend through holes in said fin.

14. The convection heater of claim 12, wherein at least some of said heating elements do not extend through holes in said fin.

15. The convection heater of claim 9, further comprising means for supporting said heater on a substantially horizontal surface.

16. The convection heater of claim 15, wherein said means for supporting comprises devices selected from castors, legs, and combinations thereof.

17. The convection heater of claim 15, further comprising means for controlling said heating element.

18. The convection heater of claim 17, wherein said means for controlling comprises devices selected from temperature controllers, power controllers, and combinations thereof.

19. The convection heater of claim 15, further comprising handles.
